(19) United States
(12) Patent Application Publication
(10) Pub. No.: US 2020/0378689 A1
(43) Pub. Date: Dec. 3, 2020

(54) HEAT PIPE, HEAT PIPE ASSEMBLY AND METHOD FOR ASSEMBLING HEAT PIPE ASSEMBLY

(71) Applicants: Inventec (Pudong) Technology Corporation, Shanghai (CN); INVENTEC CORPORATION, Taipei (TW)

(72) Inventors: Chi-Zen PENG, Taipei (TW); Chia-Chen CHEN, Taipei (TW); Ting-Yuan LIN, Taipei (TW)

(21) Appl. No.: 16/539,132

(22) Filed: Aug. 13, 2019

(30) Foreign Application Priority Data
May 29, 2019 (CN) 201910456345.0

(51) Int. Cl. F28D 15/02; F16L 37/58

(52) U.S. Cl. CPC F28D 15/0275; F16L 37/24; F16L 37/58

(57) ABSTRACT

A heat pipe, a heat pipe assembly and a method for assembling the heat pipe assembly. The heat pipe includes a main body part and an insertion part. The insertion part is connected to the main body part. The main body part and the insertion part together form a single hollow pipe. The insertion part has an outer surface and at least one recessed part formed on the outer surface.

### CROSS-REFERENCE TO RELATED APPLICATIONS

This non-provisional application claims priority under 35 U.S.C. § 119(a) on Patent Application No(s). 201910456345.0 filed in China, on May 29, 2019, the entire contents of which are hereby incorporated by reference.

### BACKGROUND OF THE INVENTION

### Technical Field of the Invention

The disclosure relates to a heat pipe, a heat pipe assembly and a method for assembling the heat pipe assembly, more particularly to a pivotable heat pipe, heat pipe assembly having the same, and a method for assembling the same.

### Description of the Related Art

As the processing speed and performance of an electronic device such as central processing unit (CPU) progress, a large amount of heat is generated during operation. The heat needs to be removed as soon as possible; otherwise the electronic device's internal temperature will increase. If the electronic device gets too hot internally, its internal circuits can be damaged. For a slim and compact portable electronic product, such as a laptop computer, it has a very limited internal space so there is no room for air cooling devices.

Therefore, some use heat pipes as an efficient heat transfer component for heat dissipation. Specifically, there are two heat pipes partially sleeved with each other and respectively thermally connected to a heat source and a display casing so that the heat generated from the heat source can be transferred to the display casing and dissipated to the environment.

In order to pivot the heat pipes relative to each other smoothly and easily, lubricant is usually put on the contact surfaces between the heat pipes. The lubricant is added into an insertion hole on one of the heat pipes for the insertion of the other heat pipe. However, the amount of the lubricant being added into the insertion hole is not visually accessible, so it is difficult to determine a precise amount of lubricant for the insertion hole. Too less lubricant is harmful for the operation of the heat pipes. Too much lubricant may force the heat pipes to separate from each other, resulting in leakage of the lubricant. Therefore, either too less or too much lubricant has a negative effect on the quality of the heat pipe assembly.

### SUMMARY OF THE INVENTION

One embodiment of this disclosure provides aa heat pipe including a main body part and an insertion part. The insertion part is connected to the main body part. The main body part and the insertion part together form a single hollow pipe. The insertion part has an outer surface and at least one recessed part formed on the outer surface.

Another embodiment of this disclosure provides a heat pipe assembly including a first heat pipe and a second heat pipe. The first heat pipe has an insertion hole. The second heat pipe includes a main body part and an insertion part. The insertion part is connected to the main body part. The main body part and the insertion part together form a single hollow pipe. The insertion part is pivotally disposed in the insertion hole. The insertion part has an outer surface and at least one recessed part formed on the outer surface.

Still another embodiment of this disclosure provides a method for assembling a heat pipe assembly including adding a lubricant in a recessed part of an insertion part of one heat pipe of the heat pipe assembly; inserting the insertion part of the one heat pipe into an insertion hole of another heat pipe of the heat pipe assembly, and pivoting the one heat pipe relative to the another heat pipe to coat the lubricant on a surface that forms the insertion hole of the another heat pipe.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a perspective view of a heat pipe assembly according to a first embodiment of the disclosure being disposed in an electronic device;

FIG. 2 is an exploded view of the heat pipe assembly in FIG. 1;

FIG. 3 is a partially enlarged view of a second heat pipe in FIG. 2;

FIG. 4 to FIG. 8 illustrate an assembly process of the heat pipe assembly according to the first embodiment of the disclosure;

FIG. 9 is a partially enlarged perspective view of a second heat pipe according to a second embodiment of the disclosure; and

FIG. 10 is a partially enlarged perspective view of a second heat pipe according a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

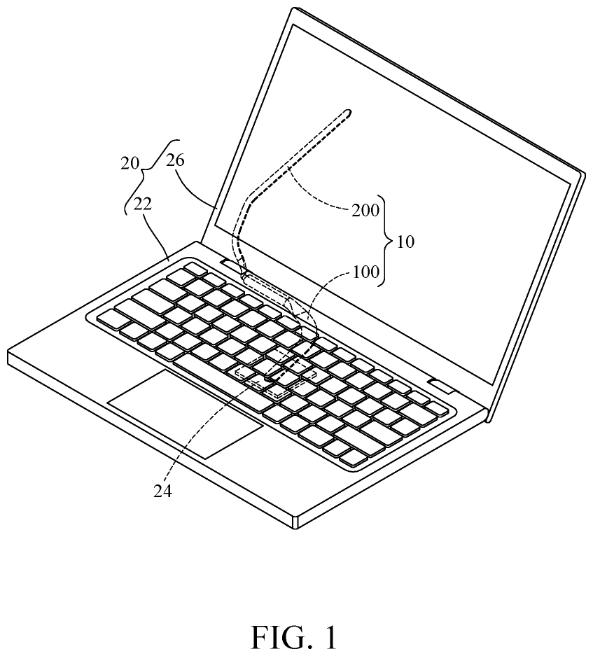

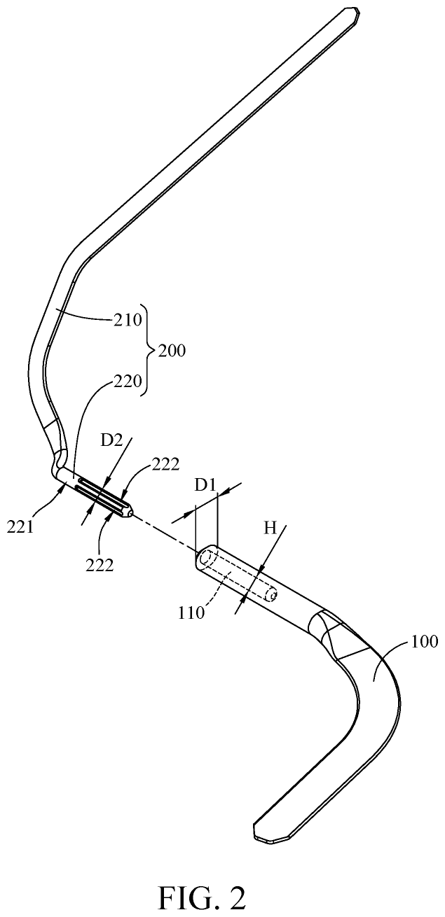

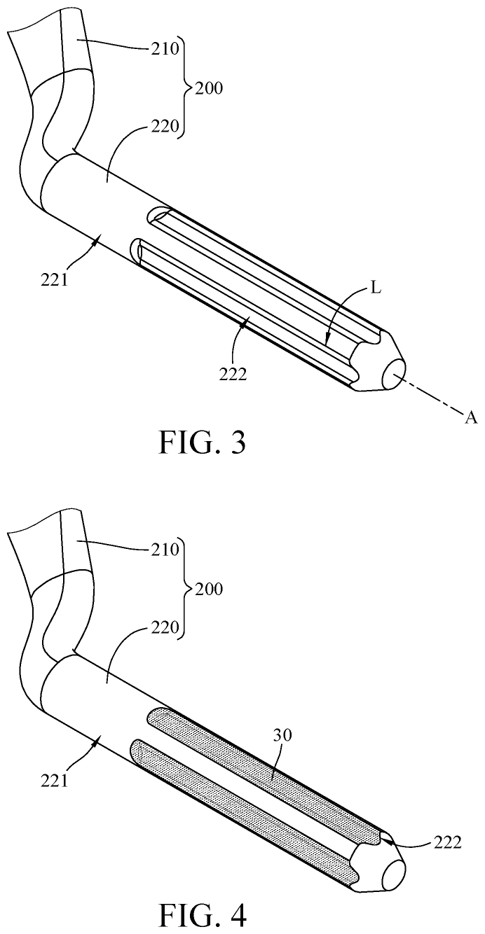

Please refer to FIG. 1 to FIG. 3. FIG. 1 is a perspective view of a heat pipe assembly according to a first embodiment of the disclosure being disposed in an electronic device. FIG. 2 is an exploded view of the heat pipe assembly in FIG. 1. FIG. 3 is a partially enlarged view of a second heat pipe in FIG. 2.

This embodiment provides a heat pipe assembly 10. The heat pipe assembly 10 can be disposed in an electronic device 20, such as a laptop computer, a tablet computer, a foldable phone, or other foldable electronic devices. As shown in FIG. 1, the laptop computer is merely an example of the electronic device 20 for explaining the spirit of the disclosure. The electronic device 20 may include a host body 22 and a display body 26. A heat source 24 can be disposed in the host body 22, and may be a central processing unit (CPU), a Southbridge chip, a Northbridge chip, or a graphic processing unit (GPU). A display panel can be disposed in the display body 26 for displaying images. The display body 26 is pivotally connected the host body 22 so that the display body 26 and the host body 22 can be pivoted relative to each other.

The heat pipe assembly 10 includes a first heat pipe 100 and a second heat pipe 200. The first heat pipe 100 is disposed in the host body 22 of the electronic device 20 and in thermal contact with the heat source 24. The first heat pipe 100 has an insertion hole 110 for the insertion of the second heat pipe 200. The second heat pipe 200 is disposed in the display body 26 and includes a main body part 210 and an insertion part 220. The main body part 210 is a pipe whose radial cross section is non-circular. The main body part 210 is in thermal contact with a casing (not numbered) of the display body 26, where the casing may be made of metal or other thermal conductive materials. The insertion part 220 is connected to the main body part 210. The insertion part 220 and the main body part 210 together form a single hollow pipe, and the hollow pipe, i.e., the second heat pipe 200 has a flow channel for coolant. The insertion part 220 is pivotally inserted into the insertion hole 110 of the first heat pipe 100, such that the second heat pipe 200 can be pivoted relative to the first heat pipe 100 when the display body 26 is pivoted relative to the host body 22.

In this embodiment, the maximum width D1 of the part of the first heat pipe 100 surrounding the insertion hole 110 is larger than a diameter D2 of the insertion part 220 of the second heat pipe 200. For example, the maximum width D1 can be approximately 8 millimeters, a diameter H of the insertion hole 110 can approximately be 4 millimeters, and the diameter D2 of the insertion part 220 also can approximately be 4 millimeters.

In this embodiment, the insertion part 220 has an outer surface 221 and a plurality of recessed parts 222 formed on the outer surface 221. The recessed parts 222 may be spaced apart from one another. Each recessed part 222 has a longitudinal edge L parallel to an axis A of the insertion part 220. That is, the recessed parts 222 extend along the axial direction of the insertion part 220. Lubricant can be added to the recessed parts 222.

Noted that the quantity of the recessed parts 222 on the insertion part 220 is not particularly restricted. In other embodiments, the insertion part of the second heat pipe may only has one recessed part.

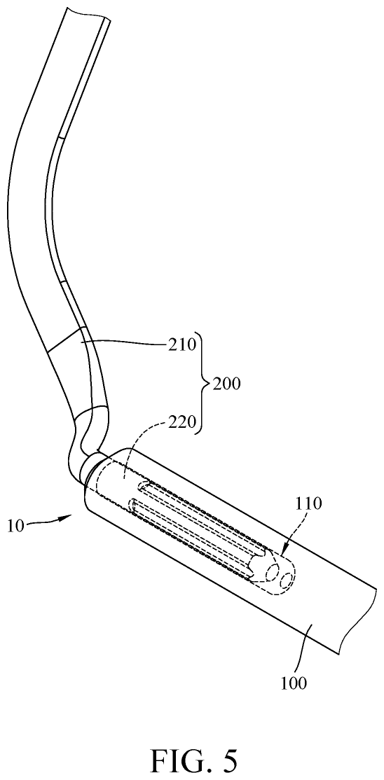

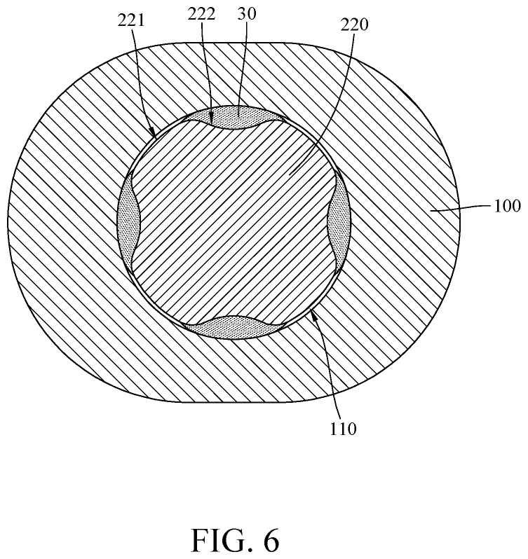

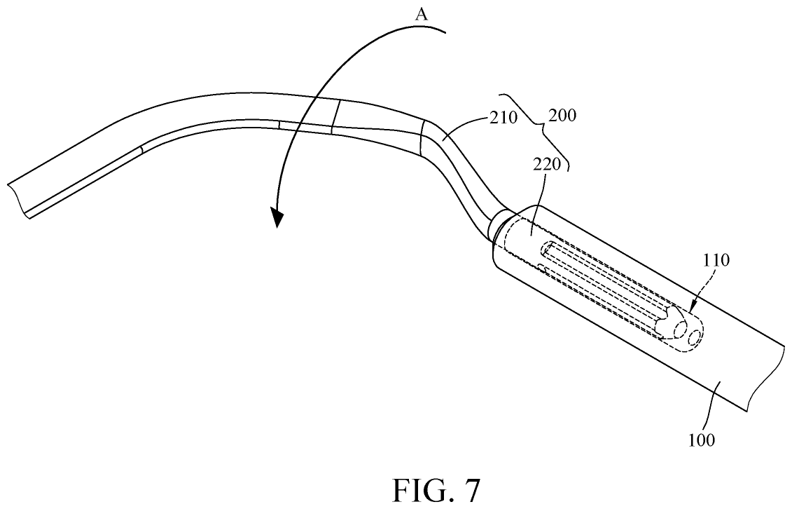

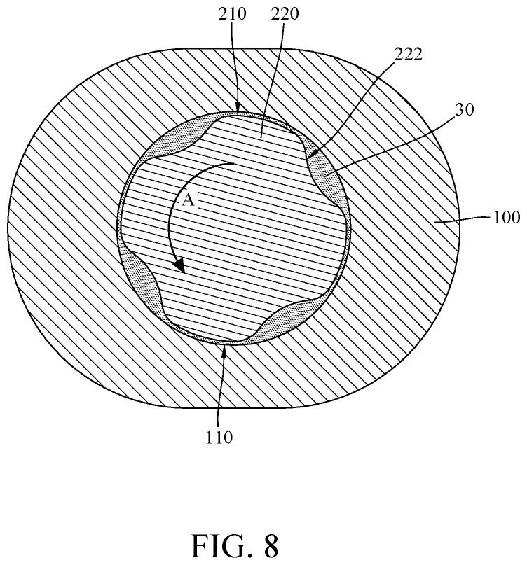

Then, please refer to FIG. 4 to FIG. 8 to introduce the method of assembling the heat pipe assembly 10. Firstly, as shown in FIG. 4, lubricant 30 is added to the recessed parts 222 of the insertion part 220 of the second heat pipe 200. Then, as shown in FIG. 5 and FIG. 6, the insertion part 220 of the second heat pipe 200 is inserted into the insertion hole 110 of the first heat pipe 100. During the insertion of the insertion part 220, the lubricant 30 in the recessed parts 222 touches the inner surface (not numbered) that forms the insertion hole 110 so as to be coated on part of the inner surface. Then, as shown in FIG. 7 and FIG. 8, the second heat pipe 200 is pivoted relative to the first heat pipe 100 along, for example, a direction A in order to coat the lubricant 30 on the rest part of the inner surface of the insertion hole 110. By doing so, the inner surface that forms the insertion hole 110 can be fully covered by the lubricant 30. As a result, the lubricant 30 can be spread uniformly along the inner surface forming the insertion hole 110.

It is understood that the required amount of the lubricant 30 relates to the size of the recessed parts 222; therefore, the amount of the lubricant 30 can be precisely determined according to the size of the recessed parts 222. Accordingly, it is possible to prevent from adding too less or too much lubricant to the recessed parts 222, thereby ensuring the smooth operation of the heat pipes, preventing the heat pipes from being detached by the lubricant, and preventing the leakage of the lubricant.

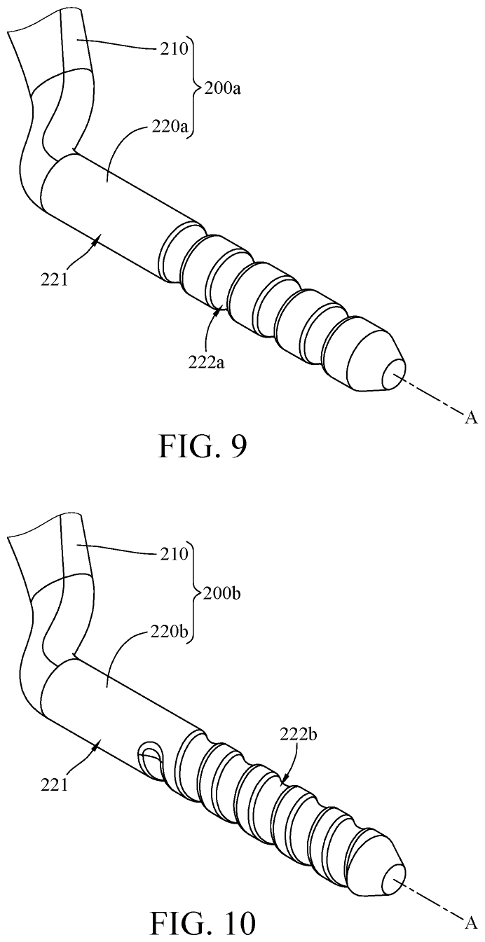

However, the longitudinal edge L of the surface forming the recess 222 is not limited to be parallel to the axis A of the pivotable part 220. Please refer to FIG. 9 and FIG. 10. FIG. 9 is a partially enlarged perspective view of a second heat pipe according to a second embodiment of the disclosure. FIG. 10 is a partially enlarged perspective view of a second heat pipe according a third embodiment of the disclosure.

As shown in FIG. 9, in this embodiment, a second heat pipe 200a includes a main body part 210 and an insertion part 220a. The main body part 210 in this embodiment and the main body part 210 in the previous embodiments are similar in configuration, so the descriptions thereof are not described in detail below. The insertion part 220a has an outer surface 221 and a plurality of recessed parts 222a. The recessed parts 222a are spaced apart from each other and arranged along the axis A of the insertion part 220a, and each of them are disposed about the axis A of the insertion part 220a.

As shown in FIG. 10, in this embodiment, the second heat pipe 200b includes a main body part 210 and an insertion part 220b. The main body part 210 in this embodiment and the main body part 210 in the previous embodiments are similar in configuration, so the descriptions thereof are not described in detail below. The insertion part 220b has an outer surface 221 and a recessed part 222b. The recessed part 222b is a helix-shaped recess formed on the outer surface 221 and disposed about the axis A of the insertion part 220b.

According to the heat pipe, the heat pipe assembly having the same, and the method for assembling the same discussed above, the lubricant is added in the recessed parts of the insertion part of the second heat pipe, rather than in the insertion hole of the first heat pipe, so a precise or suitable amount of lubricant is put between the heat pipes so as to ensure the smooth operation of the heat pipes and to avoid too much of lubricant to detach the heat pipes and thus preventing the leakage of the lubricant.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A heat pipe, comprising:
a main body part; and
an insertion part, connected to the main body part, wherein the main body part and the insertion part together form a single hollow pipe;
wherein, the insertion part has an outer surface and at least one recessed part formed on the outer surface.

2. The heat pipe according to claim 1, wherein a longitudinal edge of the at least one recessed part is parallel to an axis of the insertion part.

3. The heat pipe according to claim 2, wherein the at least one recessed part extends along an axial direction of the insertion part.

4. The heat pipe according to claim 2, wherein a quantity of the at least one recessed part is plural.

5. The heat pipe according to claim 1, wherein the at least one recessed part is disposed about an axis of the insertion part.

6. A heat pipe assembly, comprising:
a first heat pipe, having an insertion hole; and
a second heat pipe, comprising:
a main body part; and
an insertion part, connected to the main body part, wherein the main body part and the insertion part together form a single hollow pipe, and the insertion part pivotally disposed in the insertion hole of the first heat pipe;
wherein, the insertion part has an outer surface and at least one recessed part formed on the outer surface.

7. The heat pipe assembly according to claim 6, wherein a longitudinal edge of the at least one recessed part is parallel to an axis of the insertion part.

8. The heat pipe assembly according to claim 7, wherein the at least one recessed part extends along an axial direction of the insertion part.

9. The heat pipe assembly according to claim 7, wherein a quantity of the at least one recessed part is plural.

10. A method for assembling a heat pipe assembly, comprising:
adding a lubricant in a recessed part of an insertion part of one heat pipe of the heat pipe assembly;
inserting the insertion part of the one heat pipe into an insertion hole of another heat pipe of the heat pipe assembly; and
pivoting the one heat pipe relative to the another heat pipe to coat the lubricant on a surface that forms the insertion hole of the another heat pipe.
